(19) United States
(12) Patent Application Publication
(10) Pub. No.: US 2023/0296527 A1
(43) Pub. Date: Sep. 21, 2023

(54) METHOD OF ANALYZING ANTIMONY ION, INSPECTION TOOL USED FOR ANALYZING PENTAVALENT ANTIMONY ION, AND INSPECTION TOOL USED FOR ANALYZING ANTIMONY ION ACCORDING TO ITS VALENCE

(71) Applicant: KABUSHIKI KAISHA TOSHIBA, Tokyo (JP)

(72) Inventors: Mitsuhiro OKI, Kawasaki (JP); Sayaka MORIMOTO, Kawasaki (JP)

(73) Assignee: KABUSHIKI KAISHA TOSHIBA, Tokyo (JP)

(21) Appl. No.: 17/887,582

(22) Filed: Aug. 15, 2022

(30) Foreign Application Priority Data
Mar. 16, 2022 (JP) 2022-041804

(51) Int. Cl. G01N 21/78

(52) U.S. Cl. CPC G01N 21/78

(57) ABSTRACT

A method of analyzing an antimony ion of an embodiment, the method includes using a first analysis solution or a second analysis solution, the first analysis solution containing trivalent antimony ions and pentavalent antimony ions, the second analysis solution being a solution obtained by mixing a first acid and the first analysis solution, and mixing the first analysis solution or the second analysis solution with a second acid to obtain a third analysis solution in which the pentavalent antimony ions are chlorinated and which contains [SbCl₆]⁻ ions, mixing the third analysis solution and a first organic solvent and phase-separating the mixture into a fourth analysis solution as an organic phase and an aqueous phase to obtain the fourth analysis solution, mixing the fourth analysis solution and a coloring liquid containing rhodamine B to obtain a fifth analysis solution, and evaluating a concentration of the pentavalent antimony ions in the first analysis solution from color of the fifth analysis solution. A total concentration of nitric acid, cerium (IV) nitrate, and cerium (IV) sulfate contained in the first analysis solution is 0.00 mol/L or more and 0.1 mol/L or less. The total concentration of nitric acid, cerium (IV) nitrate, and cerium (IV) sulfate contained in the first acid is 0.00 mol/L or more and 0.1 mol/L or less. The total concentration of nitric acid, cerium (IV) nitrate, and cerium (IV) sulfate contained in the second acid is 0.00 mol/L or more and 0.1 mol/L or less.

### CROSS-REFERENCE TO RELATED APPLICATION

This application is based upon and claims the benefit of priority from Japanese Patent Application No. 2022-41804, filed on Mar. 16, 2022, the entire contents of which are incorporated herein by reference.

### FIELD

Embodiments described herein relate generally to a method of analyzing an antimony ion, an inspection tool used for analyzing a pentavalent antimony ion, and an inspection tool used for analyzing the antimony ion according to its valence.

### BACKGROUND

In recent years, regulations on chemical substances have become stricter, and as a company that manufactures electric and electronic devices and the like, management of chemical substances in constituent materials used for products has become very important.

Antimony oxide is used for a clarifying agent for glass, a flame retardant for resin, and the like. Since antimony has different toxicity depending on the valence, a method capable of analyzing antimony according to its valence is required.

Although an antimony concentration can be determined by X-ray fluorescence analysis, evaluation according to the valence cannot be performed; therefore, the X-ray fluorescence analysis is not suitable when it is desired to evaluate the concentration according to the valence.

In order to analyze the antimony according to its valence, hydride generation ICP mass spectrometry (HG-ICP/MS) or the like is used. However, such a device is large-scale and is not suitable as a screening method, and a screening method according to the valence capable of performing simple analysis is required.

### BRIEF DESCRIPTION OF THE DRAWINGS

FIG. 1 is a flowchart according to an embodiment;

FIG. 2 is a schematic view of an inspection tool used for analyzing a pentavalent antimony ion according to the embodiment;

FIG. 3 is according to the embodiment;

FIG. 4 is a flowchart according to an embodiment; and

FIG. 5 is a schematic view of an inspection tool used for analyzing the antimony ion according to its valence according to the embodiment.

### DETAILED DESCRIPTION

A method of analyzing an antimony ion of an embodiment, the method includes using a first analysis solution or a second analysis solution, the first analysis solution containing trivalent antimony ions and pentavalent antimony ions, the second analysis solution being a solution obtained by mixing a first acid and the first analysis solution, and mixing the first analysis solution or the second analysis solution with a second acid to obtain a third analysis solution in which the pentavalent antimony ions are chlorinated and which contains [SbCl₆]⁻ ions, mixing the third analysis solution and a first organic solvent and phase-separating the mixture into a fourth analysis solution as an organic phase and an aqueous phase to obtain the fourth analysis solution, mixing the fourth analysis solution and a coloring liquid containing rhodamine B to obtain a fifth analysis solution, and evaluating a concentration of the pentavalent antimony ions in the first analysis solution from color of the fifth analysis solution. A total concentration of nitric acid, cerium (IV) nitrate, and cerium (IV) sulfate contained in the first analysis solution is 0.00 mol/L or more and 0.1 mol/L or less. The total concentration of nitric acid, cerium (IV) nitrate, and cerium (IV) sulfate contained in the first acid is 0.00 mol/L or more and 0.1 mol/L or less. The total concentration of nitric acid, cerium (IV) nitrate, and cerium (IV) sulfate contained in the second acid is 0.00 mol/L or more and 0.1 mol/L or less.

An inspection tool used for analyzing pentavalent antimony ions of an embodiment, the inspection tool includes a first container containing a first acid in which a total concentration of nitric acid, cerium (IV) nitrate, and cerium (IV) sulfate is 0.00 mol/L or more and 0.1 mol/L or less, a second container containing a second acid in which the total concentration of nitric acid, cerium (IV) nitrate, and cerium (IV) sulfate is 0.00 mol/L or more and 0.1 mol/L or less, a third container containing a first organic solvent, and a fourth container containing a coloring liquid containing rhodamine B.

An inspection tool used for analyzing an antimony ion according to its valence of an embodiment, the inspection tool includes a first container containing a first acid in which a total concentration of nitric acid, cerium (IV) nitrate, and cerium (IV) sulfate is 0.00 mol/L or more and 0.1 mol/L or less, a second container containing a second acid in which the total concentration of nitric acid, cerium (IV) nitrate, and cerium (IV) sulfate is 0.00 mol/L or more and 0.1 mol/L or less, third container containing a first organic solvent as one or more selected from the group consisting of diisopropyl ether, diethyl ether, ethyl methyl ether, dibutyl ether, 1-octanol, chloroform, carbon tetrachloride, benzene, and hexane, a fourth container containing the coloring liquid, a fifth container containing the third acid in which a total concentration of cerium (IV) nitrate and cerium (IV) sulfate is 0.02 mol/L or more and 1.0 mol/L or less, a sixth container containing a fourth acid containing 2 mol/L or more and 12 mol/L or less of hydrochloric acid, and a seventh container containing a second organic solvent as one or more selected from the group consisting of diisopropyl ether, diethyl ether, ethyl methyl ether, dibutyl ether, 1-octanol, chloroform, carbon tetrachloride, benzene, and hexane.

Hereinafter, an embodiment will be described in detail with reference to the drawings. In the embodiment, unless otherwise specified, a condition for performing at 25° C. and atmospheric pressure (100 [kPa]) is given. In the following steps, the whole or partial amount of each solution may be used.

### First Embodiment

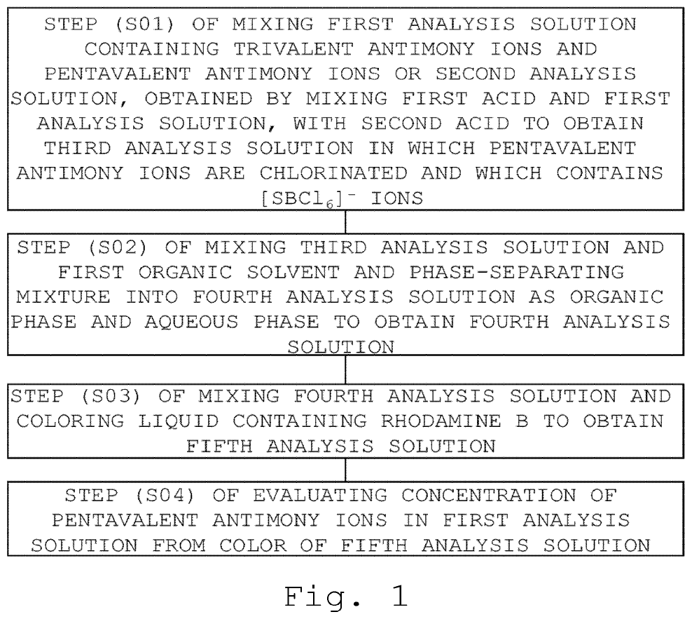

As shown in a flowchart according to an embodiment of FIG. 1, an analysis method according to a first embodiment includes: a step (S01) of mixing a first analysis solution containing trivalent antimony ions and pentavalent antimony ions or a second analysis solution, obtained by mixing a first acid and the first analysis solution, with a second acid to obtain a third analysis solution in which the pentavalent antimony ions are chlorinated and which contains [SbCl₆]⁻ ions; a step (S02) of mixing the third analysis solution and a first organic solvent and phase-separating the mixture into a fourth analysis solution as an organic phase and an aqueous phase to obtain a fourth analysis solution; and a step (S03) of mixing the fourth analysis solution and a coloring liquid containing rhodamine B to obtain a fifth analysis solution; and a step (S04) of evaluating a concentration of the pentavalent antimony ions in the first analysis solution from color of the fifth analysis solution.

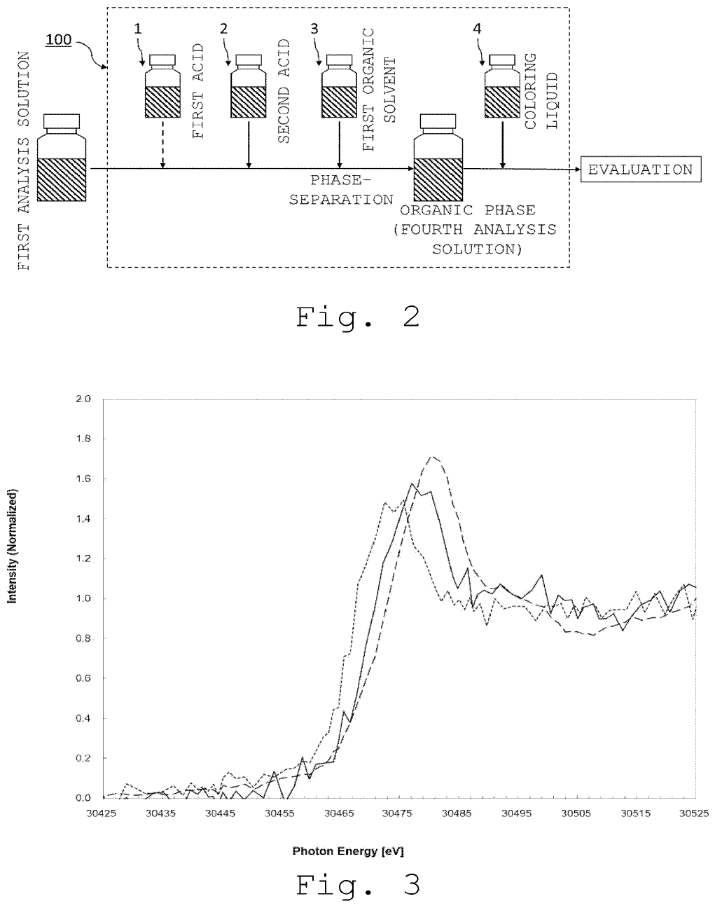

In the analysis method according to the first embodiment, it is preferable to use an inspection tool 100 used for analyzing pentavalent antimony ions and including a first container 1 containing the first acid, a second container 2 containing the second acid, a third container 3 containing the first organic solvent, and a fourth container 4 containing the coloring liquid. FIG. 2 is a schematic view of the inspection tool 100 of the first embodiment. The schematic diagram of FIG. 2 also briefly illustrates a procedure for analyzing pentavalent antimony ions using the inspection tool 100. In FIG. 2, since mixing of the first acid and the first analysis solution may be omitted, the arrow from the first container 1 is indicated by a broken line.

The first container 1, the second container 2, the third container 3, and the fourth container 4 are preferably glass or synthetic resin containers. Each container may have a bottle shape or a tube shape. Each container is provided with an opening. The opening is provided with a valve or a lid for preventing leakage of the solution. Each solution can be transferred to another solution using any of a pipette, a dropper, and a syringe.

There will be described the step (S01) of mixing the first analysis solution containing trivalent antimony ions and pentavalent antimony ions or the second analysis solution, obtained by mixing the first acid and the first analysis solution, with the second acid to obtain the third analysis solution in which the pentavalent antimony ions are chlorinated and which contains [SbCl₆]⁻ ions. In other words, in this step (S01), the first analysis solution or the second analysis solution is used, the first analysis solution contains trivalent antimony ions and pentavalent antimony ions, the second analysis solution is a solution obtained by mixing the first acid and the first analysis solution, the first analysis solution or the second analysis solution is mixed with the second acid to obtain the third analysis solution in which the pentavalent antimony ions are chlorinated and which contains [SbCl₆]⁻ ions.

In this step, the trivalent antimony ions and the pentavalent antimony ions contained in the first analysis solution to be analyzed are chlorinated. The step (S01) of mixing the first analysis solution containing trivalent antimony ions and pentavalent antimony ions or the second analysis solution, obtained by mixing the first acid and the first analysis solution, with the second acid to obtain the third analysis solution in which the pentavalent antimony ions are chlorinated and which contains [SbCl₆]⁻ ions may be abbreviated as a first step. The chlorinated antimony ion represents an antimony ion coordinated with a chloride ion.

In the first step, the third analysis solution obtained by chlorinating the pentavalent antimony ions contained in the first analysis solution is obtained without oxidizing (with substantially not oxidizing) the trivalent antimony ions contained in the first analysis solution to the pentavalent antimony ions.

The first analysis solution is a solution containing trivalent antimony ions and pentavalent antimony ions. The first analysis solution is a solution obtained by, for example, dissolving a sample such as a resin or a metal or extracting antimony from the sample. The antimony in the sample to be analyzed can be evaluated in embodiments.

The first analysis solution contains water in addition to antimony ions and an acid. The first analysis solution may contain other metal ions and the like in addition to antimony ions, acids, and water. The first analysis solution preferably does not contain at least one selected from the group consisting of gold, thallium, and gallium that may inhibit the analysis of antimony ions in a concentration of 1% or more of the antimony ion concentration [mol %] of the first analysis solution, and more preferably does not contain at all.

In the first step, the first analysis solution or the second analysis solution obtained by mixing the first acid and the first analysis solution is mixed with the second acid. An object to be mixed with the second acid is the first analysis solution or the second analysis solution obtained by mixing the first acid and the first analysis solution.

When a pH of the solution is high in the first step, chlorination of antimony ions does not proceed, and therefore, the pH of the first analysis solution or the second analysis solution is preferably low. When the pH of the first analysis solution is high, it is preferable to mix the first acid with the first analysis solution.

The pH of the first analysis solution is preferably 3 or less. The lower limit of the pH of the first analysis solution is not particularly limited, and the pH of the first analysis solution is preferably −1 (minus one) or more and 3 or less. The first analysis solution having a pH higher than 3 is mixed with the second acid. When the pH of the first analysis solution is higher than 3, the first acid and the first analysis solution having a pH higher than 3 are mixed to obtain a second analysis solution having a pH of 3 or less. The lower limit of the pH of the second analysis solution is not particularly limited, and the pH of the first analysis solution is preferably −1 or more and 3 or less.

When the first analysis solution contains one or more selected from the group consisting of nitric acid, cerium (IV) nitrate, and cerium (IV) sulfate, trivalent antimony ions in the first analysis solution are oxidized into pentavalent antimony ions. Experiments conducted by the present inventors have revealed that nitric acid is also an oxidant of trivalent antimony. Cerium (IV) nitrate and cerium (IV) sulfate are known strong oxidizing agents.

Thus, a total concentration of nitric acid, cerium (IV) nitrate, and cerium (IV) sulfate in the first analysis solution is preferably 0.00 mol/L or more and 0.1 mol/L or less, more preferably 0.00 mol/L or more and 0.02 mol/L or less, and still more preferably, none of nitric acid, cerium (IV) nitrate, and cerium (IV) sulfate is contained (0.00 mol/L).

The concentration of nitric acid in the first analysis solution is preferably 0.00 mol/L or more and 0.1 mol/L or less, more preferably 0.00 mol/L or more and 0.02 mol/L or less, and still more preferably no nitric acid is contained at all (0.00 mol/L).

The concentration of cerium (IV) nitrate in the first analysis solution is preferably 0.00 mol/L or more and 0.1 mol/L or less, more preferably 0.00 mol/L or more and 0.02 mol/L or less, and still more preferably no cerium (IV) nitrate is contained at all (0.00 mol/L).

The concentration of cerium (IV) sulfate in the first analysis solution is preferably 0.00 mol/L or more and 0.1 mol/L or less, more preferably 0.00 mol/L or more and 0.02 mol/L or less, and still more preferably no cerium (IV) sulfate is contained at all (0.00 mol/L).

In the first embodiment, since the concentration of pentavalent antimony ions contained in the first analysis solution is evaluated, it is not preferable that an acid that oxidizes trivalent antimony ions in the first analysis solution to pentavalent antimony ions is contained in the first analysis solution. By performing analysis without oxidizing trivalent antimony ions to pentavalent, it is possible to analyze antimony according to the valence in the second embodiment. When the first analysis solution contains one or more selected from the group consisting of nitric acid, cerium (IV) nitrate, and cerium (IV) sulfate, the valence of some trivalent antimony ions has changed to pentavalent antimony ions, and the analysis according to the valence becomes difficult.

The first acid can lower the pH of the first analysis solution without oxidizing trivalent antimony ions (without changing the valence to pentavalent antimony ions). When the pH of the first acid is low, many first acids are used to lower the pH of the first analysis solution, and the concentration of antimony ions contained in a target solution decreases when the concentration of pentavalent antimony ions is evaluated. Thus, the pH of the first acid is preferably 3 or less, and more preferably 1 or less.

The first acid is preferably one or more selected from the group consisting of hydrochloric acid, sulfuric acid, hydrogen peroxide acid, and perchloric acid, more preferably hydrochloric acid or sulfuric acid, and still more preferably hydrochloric acid and sulfuric acid. The first acid preferably contains 2 mol/L or more and 12 mol/L or less of hydrochloric acid and/or 2 mol/L or more and 18 mol/L or less of sulfuric acid. When hydrochloric acid or sulfuric acid is contained, the aforementioned molar concentration may be filled with hydrochloric acid alone or sulfuric acid alone, or may be the sum of molar concentrations of hydrochloric acid and sulfuric acid.

For the reasons described above, the concentration of nitric acid contained in the first acid is preferably 0.00 mol/L or more and 0.1 mol/L or less, more preferably 0.00 mol/L or more and 0.02 mol/L or less, and still more preferably no nitric acid is contained at all (0.00 mol/L).

For the reasons described above, the concentration of cerium (IV) nitrate contained in the first acid is preferably 0.00 mol/L or more and 0.1 mol/L or less, more preferably 0.00 mol/L or more and 0.02 mol/L or less, and still more preferably no cerium (IV) nitrate is contained at all (0.00 mol/L).

For the reasons described above, the concentration of cerium (IV) sulfate contained in the first acid is preferably 0.00 mol/L or more and 0.1 mol/L or less, more preferably 0.00 mol/L or more and 0.02 mol/L or less, and still more preferably no cerium (IV) sulfate is contained at all (0.00 mol/L).

A mixing volume ratio of the first analysis solution and the first acid ([the amount of the first acid]/[the amount of the first analysis solution]) is preferably 1 or more and 100 or less, and more preferably 5 or more and 20 or less.

When the first acid contains a plurality of kinds of acids, one or a plurality of kinds of acids may be separately mixed with the first analysis solution. For example, when the second acid contains hydrochloric acid and sulfuric acid and is mixed with the first analysis solution, the first analysis solution and sulfuric acid may be mixed, and then a solution obtained by mixing the first analysis solution and sulfuric acid and hydrochloric acid may be mixed.

In the first step, when the first analysis solution and the first acid are mixed, the temperature of the first analysis solution is preferably 10° C. or more and 30° C. or less.

In the first step, when the first analysis solution and the first acid are mixed, the temperature of the first acid is preferably 10° C. or more and 30° C. or less.

In the first step, after the first analysis solution and the first acid are mixed, the temperature of the second analysis solution is preferably 10° C. or more and 30° C. or less. As long as the temperature of the second analysis solution falls within the above-mentioned range, the temperature of the first analysis solution and the temperature of the first acid are not limited.

In the first step, when the first analysis solution and the first acid are mixed, it is preferable to stir the solution by swirling or the like.

The second acid is mixed with the first analysis solution or the second analysis solution to obtain the third analysis solution. Antimony ions in the third analysis solution are chlorinated. Specifically, trivalent antimony ions in the third analysis solution are present as Sb³⁻, and pentavalent antimony ions are present as [SbCl₆]⁻.

The second acid preferably contains at least hydrochloric acid. When hydrochloric acid is contained in the second acid, the pH of the third analysis solution can be lowered, or the pH can be maintained low, and excessive chloride ions can be supplied to the first analysis solution or the second analysis solution. Chlorination of trivalent antimony ions and pentavalent antimony ions proceeds and is stabilized in a solution having a low pH and containing chloride ions in an excess amount with respect to antimony ions.

Antimony ions in the first analysis solution and the second analysis solution may also be partially chlorinated. By mixing the second acid with the first analysis solution or the second analysis solution, hydrochloric acid (chloride ion) in the solution is reliably excessive, chlorination of antimony ions is promoted, and Sb³⁻ and [SbCl₆]⁻ are stably present in the third analysis solution.

The second acid preferably contains one or more acids selected from the group consisting of sulfuric acid, hydrogen peroxide acid, and perchloric acid in addition to hydrochloric acid.

The second acid preferably contains 2 mol/L or more and 12 mol/L or less of hydrochloric acid.

In the acids contained in the second acid, the concentration (mol/L) of hydrochloric acid is preferably equal to or more than a total concentration (mol/L) of acids other than hydrochloric acid, more preferably twice or more than the total concentration (mol/L) of acids other than hydrochloric acid, and still more preferably five times or more than the total concentration (mol/L) of acids other than hydrochloric acid.

When the second acid contains one or more selected from the group consisting of nitric acid, cerium nitrate, and cerium sulfate, in the first step, trivalent antimony ions in the first analysis solution are oxidized into pentavalent antimony ions. In the first embodiment, since the concentration of pentavalent antimony ions contained in the first analysis solution is evaluated, it is not preferable that the acid that oxidizes trivalent antimony ions in the first analysis solution to pentavalent antimony ions is contained in the second acid.

For the reasons described above, the total concentration of nitric acid, cerium (IV) nitrate, and cerium (IV) sulfate contained in the second acid is preferably 0.00 mol/L or more and 0.1 mol/L or less, more preferably 0.00 mol/L or more and 0.02 mol/L or less, and still more preferably, none of nitric acid, cerium (IV) nitrate, and cerium (IV) sulfate is contained (0.00 mol/L).

For the reasons described above, the concentration of nitric acid contained in the second acid is preferably 0.00 mol/L or more and 0.1 mol/L or less, more preferably 0.00 mol/L or more and 0.02 mol/L or less, and still more preferably no nitric acid is contained at all (0.00 mol/L).

For the reasons described above, the concentration of cerium (IV) nitrate contained in the second acid is preferably 0.00 mol/L or more and 0.1 mol/L or less, more preferably 0.00 mol/L or more and 0.02 mol/L or less, and still more preferably no cerium (IV) nitrate is contained at all (0.00 mol/L).

For the reasons described above, the concentration of cerium (IV) sulfate contained in the second acid is preferably 0.00 mol/L or more and 0.1 mol/L or less, more preferably 0.00 mol/L or more and 0.02 mol/L or less, and still more preferably no cerium (IV) sulfate is contained at all (0.00 mol/L).

When the second acid contains a plurality of kinds of acids, one or a plurality of kinds of acids may be separately mixed with the first analysis solution or the second analysis solution. For example, when the second acid contains hydrochloric acid and sulfuric acid and is mixed with the first analysis solution, the first analysis solution and sulfuric acid may be mixed, and then the solution obtained by mixing the first analysis solution and sulfuric acid and hydrochloric acid may be mixed.

A mixing volume ratio of the first analysis solution and the second acid ([the amount of the second acid]/[the amount of the first analysis solution]) is preferably 1 or more and 100 or less, and more preferably 5 or more and 20 or less. Even when the concentration of antimony ions in the first analysis solution is unknown, sufficient chloride ions can be supplied to the first analysis solution by using the second acid in the above range.

A mixing volume ratio of the second analysis solution and the second acid ([the amount of the second acid]/[the amount of the second analysis solution]) is preferably 1 or more and 100 or less, and more preferably 5 or more and 20 or less. Even when the concentration of antimony ions in the second analysis solution is unknown, sufficient chloride ions can be supplied to the second analysis solution by using the second acid in the above range.

In the first step, when the first analysis solution and the second acid are mixed, the temperature of the first analysis solution is preferably 10° C. or more and 30° C. or less.

In the first step, when the first analysis solution and the second acid are mixed, the temperature of the second acid is preferably 10° C. or more and 30° C. or less.

In the first step, after the first analysis solution and the second acid are mixed, the temperature of the third analysis solution is preferably 10° C. or more and 30° C. or less. As long as the temperature of the third analysis solution falls within the above-mentioned range, the temperature of the first analysis solution and the temperature of the second acid are not limited.

In the first step, when the first analysis solution and the second acid are mixed, it is preferable to stir the solution by swirling or the like.

In the first step, when the second analysis solution and the second acid are mixed, the temperature of the second analysis solution is preferably 10° C. or more and 30° C. or less.

In the first step, when the second analysis solution and the second acid are mixed, the temperature of the second acid is preferably 10° C. or more and 30° C. or less.

In the first step, after the second analysis solution and the second acid are mixed, the temperature of the third analysis solution is preferably 10° C. or more and 30° C. or less. As long as the temperature of the third analysis solution falls within the above-mentioned range, the temperature of the second analysis solution and the temperature of the second acid are not limited.

In the first step, when the second analysis solution and the second acid are mixed, it is preferable to stir the solution by swirling or the like.

The step (S02) of mixing the third analysis solution and the first organic solvent to obtain the fourth analysis solution as a first organic phase phase-separated will be described. In this step, the first organic solvent is mixed with the third analysis solution to phase-separate the mixed solution into the fourth analysis solution as the organic phase and an aqueous phase, and thus to obtain the fourth analysis solution. The step (S02) of mixing the first organic solvent with the third analysis solution to phase-separate the mixed solution into the fourth analysis solution as the organic phase and the aqueous phase, and thus to obtain the fourth analysis solution may be abbreviated as a second step.

Since the chlorinated antimony ion is lipophilic, the antimony ion can be separated by using the first organic solvent. When the third analysis solution is phase-separated using the first organic solvent, the third analysis solution is separated into the fourth analysis solution as the organic phase (first organic phase) and a first aqueous phase as an aqueous phase.

Since the chlorinated antimony ion is easily hydrolyzed, it is preferable to extract [SbCl₆]⁻ as HSbCl₆ molecules into the first organic phase from the viewpoint of enhancing analysis accuracy.

The first organic solvent is preferably one or more selected from the group consisting of diisopropyl ether, diethyl ether, ethyl methyl ether, dibutyl ether, 1-octanol, chloroform, carbon tetrachloride, benzene, and hexane, more preferably one selected from the group consisting of diisopropyl ether, diethyl ether, ethyl methyl ether, and dibutyl ether, and still more preferably diisopropyl ether. By using these organic solvents, antimony ions as HSbCl₆ molecules can be extracted into the first organic phase.

The first aqueous phase contains the first analysis solution, the first acid, the acid contained in the second acid, and the like. Since the first aqueous phase is not the solution to be analyzed according to the first embodiment, it is preferable to separate the first organic phase and the first aqueous phase into different containers or to remove the first aqueous phase. When the first aqueous phase contains an analyte other than antimony ions, the first aqueous phase can be used for other analysis.

In the second step, when the third analysis solution and the first organic solvent are mixed, the temperature of the third analysis solution is preferably 10° C. or more and 30° C. or less.

In the second step, when the third analysis solution and the first organic solvent are mixed, the temperature of the first organic solvent is preferably 10° C. or more and 30° C. or less.

In the second step, after the third analysis solution and the first organic solvent are mixed, the temperature of the fourth analysis solution is preferably 10° C. or more and 30° C. or less. As long as the temperature of the fourth analysis solution falls within the above-mentioned range, the temperature of the third analysis solution and the temperature of the first organic solvent are not limited.

In the second step, when the third analysis solution and the first organic solvent are mixed, it is preferable to stir the solution by swirling or the like. In the second step, it is preferable to perform stirring vigorously. Thus, when the third analysis solution and the first organic solvent are mixed and stirred, a flow rate of a solution obtained by mixing the third analysis solution and the first organic solvent is preferably 0.1 m/s or more and 1 m/s or less. It is preferable to stir a solution A a plurality of times in vertical and horizontal directions, specifically, 10 times or more and 50 times or less so that the solution A hits a wall surface of a container containing the solution (solution A) obtained by mixing the third analysis solution and the first organic solvent at this flow rate. The stirring time is preferably 0.5 minutes or more and 3 minutes or less. In the second step, when the third analysis solution and the first organic solvent are stirred, the temperature of the solution is preferably 10° C. or more and 30° C. or less.

In the second step, it is preferable to leave the solution after stirring at a temperature of 40° C. or more and 70° C. or less for 0.5 minutes or more and 3 minutes or less to phase-separate the solution.

From the viewpoint of suppressing hydrolysis of the chlorinated antimony ions, the temperature of the third analysis solution is preferably 10° C. or more and 30° C. or less when the first step is shifted to the second step, and it is preferable to perform the second step within 10 minutes at this temperature. From the same viewpoint, it is not preferable to add an alkaline solution such as sodium hydroxide, chlorine gas, and the like to the third analysis solution in the process from the first step to the second step. From the same viewpoint, after the first step is completed, it is preferable to perform the second step without adding anything to the third analysis solution except unavoidable contamination at 10° C. or more and 30° C. or less within 0 minute or more and 10 minutes.

The step (S03) of mixing the fourth analysis solution and a coloring liquid containing rhodamine B to obtain the fifth analysis solution will be described. In this step, the fourth analysis solution and the coloring liquid are mixed. When the first analysis solution contains pentavalent antimony ions, the color of the solution of the fifth analysis solution changes. The step (S03) of mixing the fourth analysis solution and the coloring liquid containing rhodamine B to obtain the fifth analysis solution may be abbreviated as a third step.

The coloring liquid is, for example, a sulfuric acid acidic solution in which 0.01 g or more and 1 g or less of rhodamine B is dissolved in 1 mL or more and 100 mL or less of sulfuric acid (0.1 mol/L or more and 2 mol/L).

When the fourth analysis solution is mixed with the coloring liquid, HSbCl₆ molecules and rhodamine B form a complex, and the fifth analysis solution develops a red color. When the concentration of pentavalent antimony ion is high, a dark red color is developed, and when the concentration of pentavalent antimony ion is low, a light red color is developed. If the first analysis solution does not contain pentavalent antimony ions, the first analysis solution does not develop a red color. Sb³⁺ derived from trivalent antimony ions does not develop a red color even when mixed with rhodamine B. When an absorbance of the coloring liquid around 550 nm is high, it is difficult to evaluate the concentration of pentavalent antimony ions in the next step. Thus, the absorbance of light having a wavelength of 530 nm or more and 570 nm or less in the coloring liquid is preferably 0.01 or more and 3 or less.

In the third step, when the fourth analysis solution and the coloring liquid are mixed, the temperature of the fourth analysis solution is preferably 10° C. or more and 30° C. or less.

In the third step, when the fourth analysis solution and the coloring liquid are mixed, the temperature of the coloring liquid is preferably 10° C. or more and 30° C. or less.

In the third step, after the fourth analysis solution and the coloring liquid are mixed, the temperature of the fifth analysis solution is preferably 10° C. or more and 30° C. or less. As long as the temperature of the fifth analysis solution falls within the above-mentioned range, the temperature of the fourth analysis solution and the temperature of the coloring liquid are not limited.

In the third step, when the fourth analysis solution and the coloring liquid are mixed, it is preferable to stir the solution by swirling or the like. In the stirring in the third step, it is preferable to vigorously swirl in the same manner as the stirring in the second step.

In the third step, the temperature of the fifth analysis solution during stirring is preferably 10° C. or more and 30° C. or less.

The temperature of the fourth analysis solution is preferably 10° C. or more and 30° C. or less when the second step is shifted to the third step, and it is preferable to perform the third step within 10 minutes at this temperature. From the viewpoint of preventing unintended oxidation of trivalent antimony ions and the like, it is not preferable to add chlorine gas and the like to the fourth analysis solution in the process from the second step to the third step. From the same viewpoint, after the second step is completed, it is preferable to perform the third step without adding anything to the third analysis solution except unavoidable contamination at 10° C. or more and 30° C. or less within 0 minute or more and 10 minutes.

The step (S04) of evaluating the concentration of pentavalent antimony ions in the first analysis solution from the color of the fifth analysis solution will be described. In this step, the pentavalent antimony ion concentration is evaluated from the color of the fifth analysis solution. The step (S04) of evaluating the concentration of pentavalent antimony ions in the first analysis solution from the color of the fifth analysis solution may be abbreviated as a fourth step.

When the coloring liquid is added in the third step, the first analysis solution containing pentavalent antimony ions changes to red. Thus, the pentavalent antimony ion concentration is evaluated from the color of the fifth analysis solution. Examples of the evaluation method include a method of comparing colors of a color chart and the fifth analysis solution, and a method using an absorptiometer.

The method of comparing the colors of the color chart and the fifth analysis solution is simple and does not use a measuring instrument, and thus is suitable as a screening method. Even when the color chart is used, the absorbance at a wavelength around 550 nm can be evaluated by red color density.

In the method using the absorptiometer, the absorbance of the fifth analysis solution at a wavelength of 550 nm is evaluated. The measurement wavelength is preferably 550 nm, may be any wavelength of 530 nm or more and 570 nm or less, and is preferably any wavelength of 540 nm or more and 560 nm or less. When the absorptiometer is used, a calibration curve is prepared in advance using an antimony standard solution, and the concentration of pentavalent antimony ions in the fifth analysis solution is evaluated. When the color chart is used, it is preferable to perform evaluation in consideration of how many times the first analysis solution has been diluted with the fifth analysis solution.

The analysis of antimony ions using rhodamine B was evaluated after cerium (IV) sulfate and the like are added to the solution to be analyzed to change the valence of trivalent antimony ions to pentavalent. In this evaluation, a plurality of kinds of strong acids such as nitric acid, hydrochloric acid, sulfuric acid, and cerium (IV) sulfate are added at the time of preparation of the solution and the like, and there has been no report heretofore on a result of comparing and examining at what stage the change in valence of antimony ions occurs. Cerium (IV) sulfate and cerium (IV) nitrate are strong oxidizing agents, and therefore expected to be oxidizing agents that change the valence of trivalent antimony ions to pentavalent antimony ions; however, it has been unclear whether these other acids also act as oxidizing agents for trivalent antimony ions, and thus attention has not been paid. Thus, what kind of acid changes the valence of trivalent antimony ions to pentavalent antimony ions was evaluated by the presence or absence of treatment with cerium (IV) sulfate.

The following solutions were used for evaluation by cerium (IV) sulfate treatment.
Sample A: 10 μg/mL antimony (trivalent) solution (solution obtained by dissolving 10 μg of antimony trioxide (Sb (III)) in terms of metal antimony in 10 mL of hydrochloric acid)
Sample B: 10 μg/mL antimony (pentavalent) solution (solution obtained by dissolving 10 μg of potassium pyroantimonate (Sb (V)) in terms of metal antimony in 10 mL of pure water)
Sample C: 10 μg/mL antimony (trivalent+pentavalent) solution (solution obtained by dissolving 5 μg of antimony trioxide (Sb (III)) in terms of metal antimony and 5 μg of potassium pyroantimonate (Sb (V)) in terms of metal antimony in 10 mL of pure water)
Hydrochloric acid: 8 mol/L
Sulfuric acid: 9 mol/L
Nitric acid: 16 mol/L
Cerium (IV) sulfate solution: 30 g/L (100 mL obtained by dissolving 3.6 g of cerium (IV) sulfate tetrahydrate in 6 mL of sulfuric acid and water)
Rhodamine B solution: 100 mL obtained by dissolving 0.02 g of rhodamine B in 6 mL of 6 mol/L sulfuric acid and adding water

Test 1

3 mL of Sample A, 5 mL of nitric acid, 5 mL of sulfuric acid, 10 mL of hydrochloric acid, and 7 mL of water were mixed (treatment 1). The cerium (IV) sulfate solution was added dropwise to the mixed solution until the color of the solution turned yellow, 0.5 mL of the cerium (IV) sulfate solution was further added dropwise to the solution in the treatment 1, and after the dropwise addition, the solution was allowed to stand at room temperature for 5 minutes (treatment 2). Next, 20 mL of hydrochloric acid and 1 mL of the cerium (IV) sulfate solution were added to the solution in the treatment 2 (treatment 3). Next, 30 mL of diisopropyl ether was added to the solution of in the treatment 3, and the solution was vigorously swirled for about 2 minutes and allowed to stand, so that the solution was phase-separated into an organic phase and an aqueous phase to remove the aqueous phase (treatment 4). 5 mL of rhodamine B solution was added to the organic phase, and the mixture was vigorously swirled for 1 minute and allowed to stand (treatment 5). In Test 1, it was observed that a clear solution was changed (colored) to red by the treatment 5.

Test 2

Test 2 was similar to Test 1 except that 3 mL of Sample B was used instead of 3 mL of Sample A. In Test 2, it was observed that a clear solution was changed (colored) to red by the treatment 5.

Test 3

Test 3 was similar to Test 1 except that 3 mL of Sample C was used instead of 3 mL of Sample A. In Test 3, it was observed that a clear solution was changed (colored) to red by the treatment 5.

In all of Tests 1 to 3, a color reaction was observed. Since the color reaction was observed when HSbCl₆ was present in the solution to which rhodamine B solution was added in the treatment 5, it was found that the valence of trivalent antimony ions was changed to pentavalent antimony ions by performing the color reaction in Test 1. That is, it was found that the change in valence occurred in the treatment 1.

Test 4

Test 4 was similar to Test 1 except that the treatment 2 was omitted. In Test 4, it was observed that a clear solution was changed (colored) to red by the treatment 5.

Test 5

Test 5 was similar to Test 2 except that the treatment 2 was omitted. In Test 5, it was observed that a clear solution was changed (colored) to red by the treatment 5.

Test 6

Test 6 was similar to Test 3 except that the treatment 2 was omitted. In Test 6, it was observed that a clear solution was changed (colored) to red by the treatment 6.

In all of Tests 4 to 6, the color reaction was observed. Since the color reaction was observed when HSbCl₆ was present in the solution to which rhodamine B solution was added in the treatment 5, it was found that the valence of trivalent antimony ions was changed to pentavalent antimony ions without performing the oxidation step in the treatment 2. That is, it was found that the change in valence occurred in the treatment 1.

Test 7

Test 7 was similar to Test 1 except that the treatment 2 was omitted and hydrochloric acid was not added in the treatment 3. In Test 7, it was observed that a clear solution was changed (colored) to red by the treatment 5.

Test 8

Test 8 was similar to Test 2 except that the treatment 2 was omitted and hydrochloric acid was not added in the treatment 3. In Test 8, it was observed that a clear solution was changed (colored) to red by the treatment 5.

Test 9

Test 9 was similar to Test 3 except that the treatment 2 was omitted and hydrochloric acid was not added in the treatment 3. In Test 9, it was observed that a clear solution was changed (colored) to red by the treatment 5.

In all of Tests 7 to 9, the color reaction was observed. Since the color reaction was observed when HSbCl₆ was present in the solution to which rhodamine B solution was added in the treatment 5, it was found that the valence of trivalent antimony ions was changed to pentavalent antimony ions without performing the oxidation step in the treatment 2. That is, it was found that the change in valence occurred in the treatment 1. In addition, although it was considered that antimony ions were chlorinated by the addition of hydrochloric acid in the treatment 3, since the color reaction occurred even without this hydrochloric acid, it was expected that the change in valence and the chlorination proceeded simultaneously in the treatment 1.

Test 10

Test 10 was similar to Test 1 except that the treatments 2 and 3 were omitted. In Test 1, it was observed that a clear solution was changed (colored) to red by treatment 10.

Test 11

Test 11 was similar to Test 2 except that the treatments 2 and 3 were omitted. In Test 11, it was observed that a clear solution was changed (colored) to red by the treatment 5.

Test 12

Test 12 was similar to Test 3 except that the treatments 2 and 3 were omitted. In Test 12, it was observed that a clear solution was changed (colored) to red by the treatment 5.

In all of Tests 10 to 12, the color reaction was observed. Since the color reaction was observed when HSbCl₆ was present in the solution to which rhodamine B solution was added in the treatment 5, it was found that the valence of trivalent antimony ions was changed to pentavalent antimony ions without performing the oxidation step in the treatment 2. That is, it was found that the change in valence occurred in the treatment 1. In addition, although it was considered that antimony ions were chlorinated by the addition of hydrochloric acid in the treatment 3, since the color reaction occurred even without this hydrochloric acid, it was expected that the change in valence and the chlorination proceeded simultaneously in the treatment 1.

Test 13

Test 13 was similar to Test 1 except that nitric acid was not added in the treatment 1 and the treatments 2 and 3 were omitted. In Test 13, a clear solution was not changed to red by the treatment 5.

Test 14

Test 14 was similar to Test 2 except that nitric acid was not added in the treatment 1 and the treatments 2 and 3 were omitted. In Test 14, a clear solution was not changed to red by the treatment 5.

Test 15

Test 15 was similar to Test 3 except that nitric acid was not added in the treatment 1 and the treatments 2 and 3 were omitted. In Test 15, a clear solution was not changed to red by the treatment 5.

In all of Tests 13 to 15, no color reaction was observed. Since a change in the color of the solution could not be confirmed, it was expected that at least chlorination did not proceed in the treatment 1 in which nitric acid was not added. Since no color reaction was observed in all of Tests 13 to 15, it was not possible to determine from Test 13 to Test 15 whether the presence or absence of nitric acid caused the change in valence from trivalent antimony ions to pentavalent antimony ions.

Next, since it was found from Test 1 to Test 15 that there was a possibility that the valence of trivalent antimony ions was changed to pentavalent antimony ions in the treatment 1, evaluation was performed by an X-ray absorption fine structure (XAFS) in which valence information of a specific element is obtained. When the acid used in the treatment 1 was changed, which acid caused (did not cause) the change in valence of antimony ions when used was evaluated.

Test 16

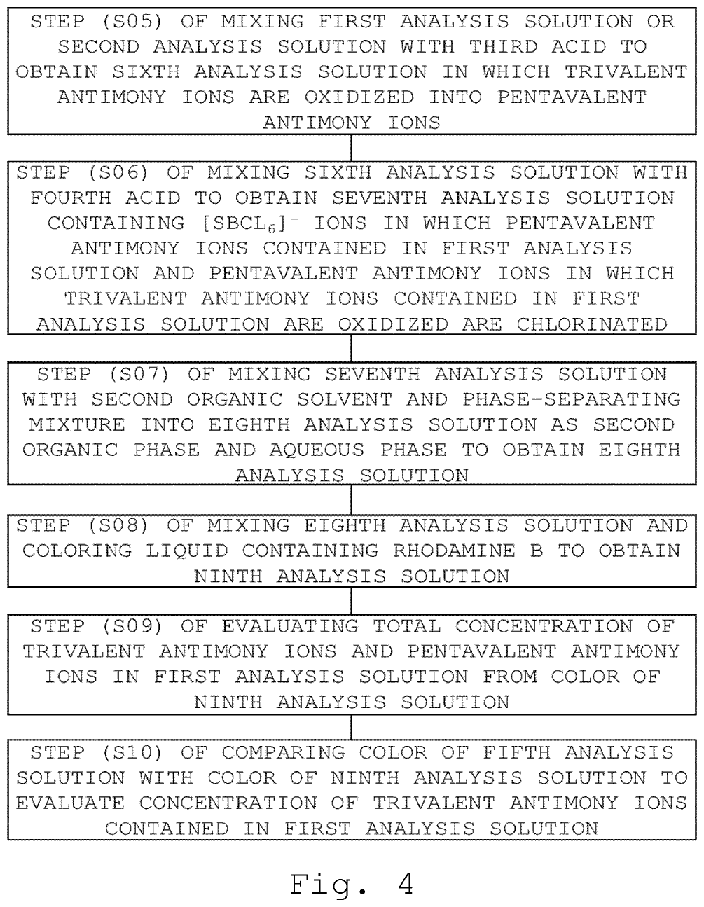

An aqueous solution containing trivalent antimony ions was evaluated by XAFS. An XAFS spectrum (dotted line) between 30425 eV and 30525 eV is shown in FIG. 3. The aqueous solution containing trivalent antimony ions of Test 16 contains 1 μg/mL of Sb³⁺ in terms of metal antimony. In the XAFS spectrum of Test 16, a peak was confirmed near 30474 eV derived from trivalent antimony.

Test 17

An aqueous solution containing pentavalent antimony ions was evaluated by XAFS. The aqueous solution containing pentavalent antimony ions of Test 17 contains 1 μg/mL of Sb⁵⁺ in terms of metal antimony. The XAFS spectrum (dashed line) between 30425 eV and 30525 eV is shown in FIG. 3. In the XAFS spectrum of Test 17, a peak was confirmed near 30480 eV derived from pentavalent antimony.

Tests 18 to 21 evaluated whether the change in valence of antimony ions occurred or not, in comparison with the results of Tests 16 and 17. Evaluation was performed, assuming that if these test results were similar to the XAFS spectrum of Test 16, the change in valence did not occur, if the result similar to the XAFS spectrum of Test 17 was obtained, the change in valence occurred, and if an intermediate result thereof was obtained, a partial change in valence occurred.

Test 18

A solution containing antimony ions was evaluated by XAFS. In an aqueous solution containing antimony ions in Test 18, water, hydrochloric acid, sulfuric acid, and nitric acid were mixed with a solution containing 1 μg/mL (concentration was a value after mixing with water and acid) of Sb³⁺ in terms of metal antimony. The solution containing antimony ions in Test 18 had a hydrochloric acid concentration of 1.5 mol/L, a sulfuric acid concentration of 1.5 mol/L, and a nitric acid concentration of 2.7 mol/L. The XAFS spectrum (solid line) between 30425 eV and 30525 eV in Test 18 is shown in FIG. 3. In the XAFS spectrum of Test 18, a peak was confirmed between 30474 eV derived from trivalent antimony and 30480 eV derived from pentavalent antimony. Since the peak was observed between 30474 eV derived from trivalent antimony and 30480 eV derived from pentavalent antimony, it was considered that the valence of some trivalent antimony ions contained in the aqueous solution containing antimony ions in Test 18 was changed to pentavalent antimony ions.

Test 19

A solution containing antimony ions was evaluated by XAFS. An aqueous solution containing antimony ions in Test 19 was the same as the aqueous solution containing antimony ions in Test 18 except that the aqueous solution containing antimony ions in Test 19 did not contain nitric acid (amount of water was increased instead of nitric acid). In the XAFS spectrum of Test 19, a peak was confirmed near 30474 eV derived from trivalent antimony. The XAFS spectrum of Test 19 substantially overlapped the XAFS spectrum of Test 16. Since the XAFS spectrum of Test 19 substantially overlapped the XAFS spectrum of Test 16, it was considered that nitric acid acted as the oxidizing agent to change the valence of trivalent antimony ions to pentavalent antimony ions.

Test 20

A solution containing antimony ions was evaluated by XAFS. An aqueous solution containing antimony ions in Test was the same as the aqueous solution containing antimony ions in Test 18 except that the aqueous solution containing antimony ions in Test 20 did not contain sulfuric acid (amount of water was increased instead of sulfuric acid). In the XAFS spectrum of Test 20, a peak was confirmed between 30474 eV derived from trivalent antimony and 30480 eV derived from pentavalent antimony. The XAFS spectrum of Test 20 substantially overlapped the XAFS spectrum of Test 18. Since the XAFS spectrum of Test 20 substantially overlapped the XAFS spectrum of Test 18, it was considered that nitric acid acted as the oxidizing agent to change the valence of trivalent antimony ions to pentavalent antimony ions.

Test 21

A solution containing antimony ions was evaluated by XAFS. An aqueous solution containing antimony ions in Test 21 was the same as the aqueous solution containing antimony ions in Test 18 except that the aqueous solution containing antimony ions in Test 21 did not contain hydrochloric acid (amount of water was increased instead of hydrochloric acid). In the XAFS spectrum of Test 21, a peak was confirmed between 30474 eV derived from trivalent antimony and 30480 eV derived from pentavalent antimony. The XAFS spectrum of Test 21 substantially overlapped with the XAFS spectrum of Test 18 and the XAFS spectrum of Test 20. Since the XAFS spectrum of Test 20 substantially overlapped with the XAFS spectrum of Test 18 and the XAFS spectrum of Test 20, it was considered that nitric acid acted as the oxidizing agent to change the valence of trivalent antimony ions to pentavalent antimony ions.

From the results of Test 18 to Test 21, there was a difference in the XAFS spectrum depending on the presence or absence of nitric acid. It was not confirmed that there was a difference in the XAFS spectrum depending on the presence or absence of hydrochloric acid and sulfuric acid. Thus, from these results, it was found that when nitric acid was added to the aqueous solution containing trivalent antimony ions, the valence was changed to pentavalent antimony ions. Thus, in the first embodiment, all steps were preferably performed under a condition that nitric acid, cerium (IV) ammonium nitrate, and cerium (IV) sulfate were not contained.

The analysis method according to the first embodiment includes: the step (S01) of mixing the first analysis solution containing trivalent antimony ions and pentavalent antimony ions or the second analysis solution, obtained by mixing the first acid and the first analysis solution, with the second acid to obtain the third analysis solution in which the pentavalent antimony ions are chlorinated and which contains [SbCl₆]⁻ ions; the step (S02) of mixing the third analysis solution and the first organic solvent and phase-separating the mixture into the fourth analysis solution as an organic phase and an aqueous phase to obtain the fourth analysis solution; and the step (S03) of mixing the fourth analysis solution and the coloring liquid containing rhodamine B to obtain the fifth analysis solution; and the step (S04) of evaluating the concentration of the pentavalent antimony ions in the first analysis solution from color of the fifth analysis solution. By performing this analysis method, the concentration of pentavalent antimony ions in the solution can be easily measured.

### Second Embodiment

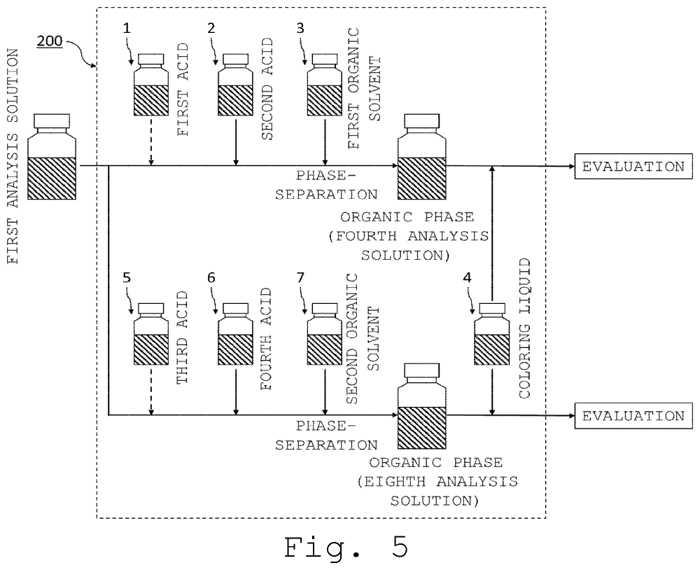

As shown in a flowchart according to an embodiment of FIG. 4, a method of analyzing antimony according to a second embodiment includes: a step (S05) of mixing a first analysis solution or a second analysis solution with a third acid to obtain a sixth analysis solution in which trivalent antimony ions are oxidized into pentavalent antimony ions; a step (S06) of mixing the sixth analysis solution with a fourth acid to obtain a seventh analysis solution containing [SbCl₆]⁻ ions in which pentavalent antimony ions contained in the first analysis solution and pentavalent antimony ions in which trivalent antimony ions contained in the first analysis solution are oxidized are chlorinated; a step (S07) of mixing the seventh analysis solution with a second organic solvent and phase-separating the mixture into an eighth analysis solution as a second organic phase and an aqueous phase to obtain the eighth analysis solution; a step (S08) of mixing the eighth analysis solution and a coloring liquid containing rhodamine B to obtain a ninth analysis solution; a step (S09) of evaluating a total concentration of trivalent antimony ions and pentavalent antimony ions in the first analysis solution from color of the ninth analysis solution; and a step (S10) of comparing color of the fifth analysis solution with the color of the ninth analysis solution to evaluate a concentration of trivalent antimony ions contained in the first analysis solution.

In an analysis step of the second embodiment, the total concentration of trivalent antimony ions and pentavalent antimony ions is evaluated by changing the valence of trivalent antimony ions to pentavalent antimony ions. Then, the concentration of trivalent antimony ions in the first analysis solution is evaluated using the evaluation result of the concentration of pentavalent antimony ions in the first analysis solution of the first embodiment.

In the method of analyzing antimony according to the second embodiment, both the analysis step of the first embodiment and the analysis step (S05 to S10) of the second embodiment are performed. In the method of analyzing antimony according to the second embodiment, the analysis step of the first embodiment and the analysis step of the second embodiment may be performed in parallel, the analysis step of the first embodiment may be performed first and the analysis step of the second embodiment may be performed later, or the analysis step of the second embodiment may be performed first and the analysis step of the first embodiment may be performed later. When the analysis step of the second embodiment is performed first and the analysis step of the first embodiment is performed later, the step (S10) of comparing the color of the fifth analysis solution with the color of the ninth analysis solution to evaluate the concentration of trivalent antimony ions contained in the first analysis solution is performed after performing the step (S04) of evaluating the concentration of pentavalent antimony ions in the first analysis solution from the color of the fifth analysis solution according to the first embodiment and the step (S09) of evaluating the total concentration of trivalent antimony ions and pentavalent antimony ions in the first analysis solution from the color of the ninth analysis solution according to the second embodiment.

In the analysis method according to the second embodiment, it is preferable to use an inspection tool 200 used for analyzing antimony ions according to the valence and including a first container 1 containing the first acid, a second container 2 containing the second acid, a third container 3 containing the first organic solvent, a fourth container 4 containing the coloring liquid, a fifth container 5 containing the third acid, a sixth container 6 containing the fourth acid, and a seventh container 7 containing the second organic solvent. FIG. 5 is a schematic view of the inspection tool 200 of the second embodiment. The schematic diagram of FIG. 5 also briefly illustrates the procedure for analyzing pentavalent antimony ions using the inspection tool 100. In FIG. 5, since mixing of the first acid and the first analysis solution may be omitted, the arrow from the first container 1 is indicated by a broken line.

When the second acid and the fourth acid are the same solution, the second container 2 and the sixth container 6 are common. When the second container 2 and the sixth container 6 are common, the second container 2 or the sixth container 6 can be omitted.

When the first organic solvent and the second organic solvent are the same solution, the third container 3 and the seventh container 7 are common. When the third container 3 and the seventh container 7 are common, the third container 3 or the seventh container 7 can be omitted.

The first container 1, the second container 2, the third container 3, the fourth container 4, the fifth container 5, the sixth container 6, and the seventh container 7 are preferably glass or synthetic resin containers. Each container may have a bottle shape or a tube shape. Each container is provided with an opening. The opening is provided with a valve or a lid for preventing leakage of the solution. Each solution can be transferred to another solution using any of a pipette, a dropper, and a syringe.

Description of contents common to the first embodiment and the second embodiment will be omitted below. In the first embodiment and the second embodiment, the first analysis solution or the second analysis solution is used.

In the first embodiment and the second embodiment, a common treatment is performed except for the presence or absence of oxidation that changes the valence of trivalent antimony ions to pentavalent antimony ions as shown in S05. In the treatments described in the first embodiment and the second embodiment, for the common treatment, reliability of the evaluation of the concentration of trivalent antimony ion in the second embodiment is improved by setting the type, amount, temperature, time, stirring method, and the like for the solution to be used to the same conditions.

The step (S05) of mixing the first analysis solution or the second analysis solution with the third acid to obtain the sixth analysis solution in which trivalent antimony ions are oxidized into pentavalent antimony ions will be described. In this step, the valence of trivalent antimony ions contained in the first analysis solution or the second analysis solution to be analyzed is changed (oxidized) to pentavalent antimony ions. The step (S05) of mixing the first analysis solution or the second analysis solution with the third acid to obtain the sixth analysis solution in which trivalent antimony ions are oxidized into pentavalent antimony ions may be abbreviated as a fifth step.

When the second analysis solution obtained by mixing the first analysis solution with the first acid is used, the first acid used in the first step of the first embodiment and the first acid used in the fifth analysis step of the second embodiment are preferably the same acid in the same amount.

In the second embodiment, the total concentration of trivalent antimony ions and pentavalent antimony ions contained in the first analysis solution is evaluated. The trivalent antimony ions do not cause the color reaction with rhodamine B. In order to measure the concentration of antimony ions including trivalent antimony ions in the second embodiment, trivalent antimony ions are oxidized to pentavalent antimony ions in the fifth step.

In the fifth step, the third acid that oxidizes trivalent antimony ions in the first analysis solution or the second analysis solution to pentavalent antimony ions is mixed with the first analysis solution or the second analysis solution. The third acid preferably contains one or more selected from the group consisting of nitric acid, cerium (IV) nitrate, and cerium (IV) sulfate. The third acid more preferably contains cerium (IV) sulfate. The third acid may further contain one or more selected from the group consisting of hydrochloric acid, sulfuric acid, hydrogen peroxide acid, and perchloric acid.

Cerium (IV) nitrate is used, for example, as a solution obtained by dissolving cerium (IV) nitrate in nitric acid. Cerium (IV) sulfate is used, for example, as a solution obtained by dissolving cerium (IV) sulfate hexahydrate in sulfuric acid. The total concentration of nitric acid, cerium (IV) nitrate, and cerium (IV) sulfate in the third acid is preferably 0.02 mol/L or more and 1.0 mol/L or less, and more preferably 0.05 mol/L or more and 0.2 mol/L or less.

When the third acid contains nitric acid, the concentration of nitric acid in the third acid is preferably 0.02 mol/L or more and 1.0 mol/L or less, and more preferably 0.05 mol/L or more and 0.2 mol/L or less.

When the third acid contains cerium (IV) nitrate, the concentration of cerium (IV) nitrate in the third acid is preferably 0.02 mol/L or more and 1.0 mol/L or less, and more preferably 0.05 mol/L or more and 0.2 mol/L or less.

When the third acid contains cerium sulfate, the concentration of cerium (IV) sulfate in the third acid is preferably 0.02 mol/L or more and 1.0 mol/L or less, and more preferably 0.05 mol/L or more and 0.2 mol/L or less.

Thus, the pH of the third acid is preferably 3 or less, and more preferably 1 or less.

A mixing volume ratio of the first analysis solution and the third acid ([the amount of the third acid]/[the amount of the first analysis solution]) is preferably 1 or more and 100 or less, and more preferably 2 or more and 50 or less. If the amount (capacity) of the third acid with respect to the amount (capacity) of the first analysis solution is too small, oxidation in which the valence of trivalent antimony ions is changed to pentavalent antimony ions becomes insufficient, and suitable analysis may not be performed.

A mixing volume ratio of the second analysis solution and the third acid ([the amount of the third acid]/[the amount of the second analysis solution]) is preferably 1 or more and 100 or less, and more preferably 2 or more and 50 or less. If the amount (capacity) of the third acid with respect to the amount (capacity) of the second analysis solution is too small, oxidation in which the valence of trivalent antimony ions is changed to pentavalent antimony ions becomes insufficient, and suitable analysis may not be performed.

When the third acid contains a plurality of kinds of acids, one or a plurality of kinds of acids may be separately mixed with the first analysis solution or the second analysis solution. For example, when the third acid contains nitric acid and sulfuric acid and is mixed with the first analysis solution, the first analysis solution and sulfuric acid may be mixed, and then a solution obtained by mixing the first analysis solution and sulfuric acid and nitric acid may be mixed.

When cerium (IV) sulfate is used for the third acid, a cerium (IV) sulfate solution is added to the first analysis solution or the second analysis solution until the color of the solution turns yellow. Then, it is preferable to further add 0.1 mL or more and 1.0 mL or less of a cerium (IV) sulfate solution to the solution turned to yellow.

In the fifth step, when the first analysis solution and the third acid are mixed, the temperature of the first analysis solution is preferably 10° C. or more and 30° C. or less.

In the fifth step, when the first analysis solution and the third acid are mixed, the temperature of the third acid is preferably 10° C. or more and 30° C. or less.

In the fifth step, when the first analysis solution and the third acid are mixed, it is preferable to stir the solution by swirling or the like.

In the fifth step, when the second analysis solution and the third acid are mixed, the temperature of the first analysis solution is preferably 10° C. or more and 30° C. or less.

In the fifth step, when the second analysis solution and the third acid are mixed, the temperature of the third acid is preferably 10° C. or more and 30° C. or less.

In the fifth step, when the second analysis solution and the third acid are mixed, it is preferable to stir the solution by swirling or the like.

In the fifth step, it is preferable to perform the sixth step after 1 minute or more has elapsed since the first analysis solution or the second analysis solution is mixed with the third acid. If the sixth step is performed immediately after the third acid is added, the change in valence of trivalent antimony ions may not sufficiently proceed. Since the oxidation reaction proceeds relatively quickly when the third acid is added, it is preferable to perform the sixth step after 1 minute or more has elapsed since the first analysis solution or the second analysis solution is mixed with the third acid. Although there is no particular upper limit, it is preferable to perform the sixth step after a lapse of 1 minute or more and 10 minutes or less, and it is more preferable to perform the sixth step after a lapse of 1 minute or more and 5 minutes or less.

The step (S06) of mixing the sixth analysis solution with the fourth acid to obtain the seventh analysis solution containing [SbCl₆]⁻ ions in which pentavalent antimony ions contained in the first analysis solution and pentavalent antimony ions in which trivalent antimony ions contained in the first analysis solution are oxidized are chlorinated will be described. In this step, pentavalent antimony ions in which the valence of trivalent antimony ions contained in the first analysis solution to be analyzed has changed and pentavalent antimony ions contained in the first analysis solution are chlorinated. The step (S06) of mixing the sixth analysis solution with the fourth acid to obtain the seventh analysis solution containing [SbCl₆]⁻ ions in which pentavalent antimony ions contained in the first analysis solution and pentavalent antimony ions in which trivalent antimony ions contained in the first analysis solution are oxidized are chlorinated may be abbreviated as a sixth step.

In the sixth step, the seventh analysis solution containing [SbCl₆]⁻ obtained by chlorinating both pentavalent antimony ions obtained by oxidizing trivalent antimony ions contained in the first analysis solution (or the second analysis solution) to pentavalent and pentavalent antimony ions contained in the first analysis solution (or the second analysis solution) is obtained.

Description of contents common to the fourth acid and the second acid will be omitted. As the fourth acid, the second acid can be used. As the fourth acid, an acid solution different from the second acid can be used.

The fourth acid is mixed with the sixth analysis solution to obtain the seventh analysis solution. Antimony ions in the seventh analysis solution are chlorinated. Specifically, pentavalent antimony ions in the seventh analysis solution are present as [SbCl₆]⁻.

The fourth acid preferably contains at least hydrochloric acid. When hydrochloric acid is contained in the fourth acid, the pH of the sixth analysis solution can be lowered, or the pH can be maintained low, and excessive chloride ions can be supplied to the third analysis solution. In the chlorination of trivalent antimony ions and pentavalent antimony ions, chloride ions having a low pH and contained in an excess amount with respect to antimony ions are preferably present.

The fourth acid used in the sixth step may contain one or more selected from the group consisting of nitric acid, cerium (IV) nitrate, and cerium (IV) sulfate. Since the sixth analysis solution contains one or more selected from the group consisting of nitric acid, cerium (IV) nitrate, and cerium (IV) sulfate that oxidize trivalent antimony ions to pentavalent antimony ions, even if the fourth acid contains one or more selected from the group consisting of nitric acid, cerium (IV) nitrate, and cerium (IV) sulfate, there is no adverse effect.

The fourth acid preferably contains, in addition to hydrochloric acid, one or more acids selected from the group consisting of nitric acid, cerium (IV) nitrate, and cerium (IV) sulfate.

A mixing volume ratio of the sixth analysis solution and the fourth acid ([the amount of the fourth acid]/[the amount of the sixth analysis solution]) is preferably 1 or more and 100 or less, and more preferably 5 or more and 20 or less. If the amount (capacity) of the fourth acid with respect to the amount (capacity) of the sixth analysis solution is too small, more specifically, if the amount of hydrochloric acid is too small, chlorination becomes insufficient, and suitable analysis may not be performed.

In the sixth step, when the sixth analysis solution and the fourth acid are mixed, the temperature of the sixth analysis solution is preferably 10° C. or more and 30° C. or less.

In the sixth step, when the sixth analysis solution and the fourth acid are mixed, the temperature of the fourth acid is preferably 10° C. or more and 30° C. or less.

In the sixth step, when the sixth analysis solution and the fourth acid are mixed, it is preferable to stir the solution by swirling or the like.

The step (S07) of mixing the seventh analysis solution with the second organic solvent and phase-separating the mixture into the eighth analysis solution as the second organic phase and the aqueous phase to obtain the eighth analysis solution will be described. In this step, the seventh analysis solution and the second organic solvent are mixed to be phase-separated into the eighth analysis solution as the second organic phase and the aqueous phase, and thus to obtain the eighth analysis solution. The step (S07) of mixing the seventh analysis solution with the second organic solvent and phase-separating the mixture into the eighth analysis solution as the second organic phase and the aqueous phase to obtain the eighth analysis solution may be abbreviated as a seventh step.

The seventh step is similar to the second step. Description of contents common to the seventh step and the second step will be omitted.

Since the chlorinated antimony ion is lipophilic, the antimony ion can be separated by using the second organic solvent. When the seventh analysis solution is phase-separated using the first organic solvent, the seventh analysis solution is separated into the eighth analysis solution as the organic phase (second organic phase) and a second aqueous phase as an aqueous phase.

The second organic solvent is preferably one or more selected from the group consisting of diisopropyl ether, diethyl ether, ethyl methyl ether, dibutyl ether, 1-octanol, chloroform, carbon tetrachloride, benzene, and hexane, more preferably one selected from the group consisting of diisopropyl ether, diethyl ether, ethyl methyl ether, and dibutyl ether, and still more preferably diisopropyl ether. By using these organic solvents, antimony ions as HSbCl₆ molecules can be extracted into the second organic phase. As the second organic solvent, the same organic solvent as the first organic solvent is preferably used. By using the same organic solvent in the first embodiment and the second embodiment, analysis conditions are similar, and the reliability of concentration evaluation is improved.

The amount (capacity) of the second organic solvent used in the seventh step is preferably 0.5 times or more and 1.5 times or less the amount (capacity) of the first organic solvent used in the second step. In the case of performing evaluation by the color chart in the fourth step and the ninth step, when a liquid to be evaluated is diluted to the same extent with the organic solvent, evaluation due to a difference in color becomes easy.

The second aqueous phase contains the first analysis solution, the acid contained in the third acid and the fourth acid, and the like. Since the second aqueous phase is not the solution to be analyzed according to the second embodiment, it is preferable to separate the second organic phase and the second aqueous phase into different containers or to remove the second aqueous phase. When the second aqueous phase contains an analyte other than antimony ions, the second aqueous phase can be used for other analysis.

The step (S08) of mixing the eighth analysis solution and a coloring liquid containing rhodamine B to obtain the ninth analysis solution will be described. In this step, the eighth analysis solution and the coloring liquid are mixed. When the first analysis solution contains trivalent antimony ions or/and pentavalent antimony ions, the color of the solution of the ninth analysis solution changes. The step (S08) of mixing the eighth analysis solution and the coloring liquid containing rhodamine B to obtain the ninth analysis solution may be abbreviated as an eighth step.

The eighth step is similar to the third step. Description of contents common to the eighth step and the third step will be omitted.

When the eighth analysis solution is mixed with the coloring liquid, the ninth analysis solution develops a red color due to HSbCl₆ molecules and rhodamine B. The coloring liquid used in the eighth step is preferably the same as the coloring liquid used in the third step. By using the same coloring liquid, the reliability of the evaluation of the antimony ion concentration is improved.

The step (S09) of evaluating the total concentration of trivalent antimony ions and pentavalent antimony ions in the first analysis solution from the color of the ninth analysis solution will be described. In this step, the pentavalent antimony ion concentration is evaluated from the color of the ninth analysis solution. The step (S09) of evaluating the total concentration of trivalent antimony ions and pentavalent antimony ions in the first analysis solution from the color of the ninth analysis solution may be abbreviated as a ninth step.

The ninth step is similar to the fourth step. Description of contents common to the ninth step and the fourth step will be omitted.

When the coloring liquid is added in the eighth step, the first analysis solution containing trivalent antimony ions or/and pentavalent antimony ions changes to red. When the antimony ion concentration is high, the red color becomes darker, and when the antimony ion concentration is low, the red color becomes lighter. Thus, the total concentration of trivalent antimony ions and pentavalent antimony ions in the first analysis solution is evaluated from the color of the ninth analysis solution. Examples of the evaluation method include a method of comparing colors of a color chart and the ninth analysis solution, and the method using the absorptiometer.

The step (S10) of comparing the color of the fifth analysis solution with the color of the ninth analysis solution to evaluate the concentration of trivalent antimony ions contained in the first analysis solution will be described. In this step, the color of the ninth analysis solution is compared with color of a fifth analysis solution, and the concentration of trivalent antimony ions contained in the first analysis solution is evaluated from the difference in color. The step (S10) of comparing the color of the fifth analysis solution with the color of the ninth analysis solution to evaluate the concentration of trivalent antimony ions contained in the first analysis solution may be abbreviated as a tenth step.

The concentration of pentavalent antimony ions (the color of the fifth analysis solution) was evaluated in the fourth step of the first embodiment, and the total concentration of trivalent antimony ions and pentavalent antimony ions (the color of the ninth analysis solution) was evaluated in the ninth step of the second embodiment. The concentration of trivalent antimony ions in the first analysis solution is evaluated by comparing these two evaluation results. When the antimony ions in the fifth analysis solution and the ninth analysis solution are diluted to the same extent, a difference in color density between the two solutions represents the concentration of trivalent antimony ions in the first analysis solution.

In the comparison using the color chart in the fourth step and the ninth step, first, dilution rates of the fifth analysis solution and the ninth analysis solution are considered. The difference in color between the two solutions is evaluated in consideration of the amounts of the first organic solvent and the second organic solvent. The color of the ninth analysis solution increases in proportion to the total concentration of trivalent antimony ions and pentavalent antimony ions contained in the first analysis solution. The color of the fifth analysis solution increases in proportion to the concentration of trivalent antimony ions in the first analysis solution. A difference in density between “the color of the ninth analysis solution in consideration of the dilution rate” and “the color of the fifth analysis solution in consideration of the dilution rate” represents the concentration of trivalent antimony ions in the first analysis solution. When the difference in density between “the color of the ninth analysis solution in consideration of the dilution rate” and “the color of the fourth analysis solution in consideration of the dilution rate” is equal to or more than a threshold, it is preferable to measure the antimony ion concentration according to the valence by a precise method such as hydride generation-ICP mass spectrometry (HG-ICP/MS).

In the comparison using an absorptiometer in the fourth step and the ninth step, the fifth analysis solution and the ninth analysis solution are measured by the same method. In the fourth step, the concentration of pentavalent antimony ions in the first analysis solution is evaluated (the concentration is determined). In the ninth step, the total concentration of trivalent antimony ions and pentavalent antimony ions in the first analysis solution is evaluated (the concentration is determined). The concentration of trivalent antimony ions is determined from a difference between “the total concentration of trivalent antimony ions and pentavalent antimony ions in the first analysis solution” and “the concentration of pentavalent antimony ions in the first analysis solution”. When the determined concentration of trivalent antimony ions is equal to or more than a threshold, it is preferable to measure the antimony ion concentration according to the valence by a precise method such as hydride generation-ICP mass spectrometry (HG-ICP/MS).

According to the method described above, it is possible to evaluate the antimony ion concentration according to the valence by a simple method without using an expensive device. Although the ion concentration can be evaluated according to the valence with high accuracy by, for example, hydride generation-ICP mass spectrometry (HG-ICP/MS) which is expensive and complicated in operation, the analysis is not easy, and therefore, it is not suitable to perform the evaluation on a sample which is unlikely to contain trivalent antimony from the viewpoint of economy and the viewpoint that rapid analysis cannot be performed. The method of the embodiment is suitable as a screening method for trivalent antimony because trivalent antimony in a sample can be evaluated simply and in a short time. Since the analysis method of the embodiment can be performed at low cost, the analysis method is an excellent analysis method also from the viewpoint of economic efficiency.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of analyzing an antimony ion, the method comprising:
using a first analysis solution or a second analysis solution, the first analysis solution containing trivalent antimony ions and pentavalent antimony ions, the second analysis solution being a solution obtained by mixing a first acid and the first analysis solution, and mixing the first analysis solution or the second analysis solution with a second acid to obtain a third analysis solution in which the pentavalent antimony ions are chlorinated and which contains [SbCl₆]⁻ ions;
mixing the third analysis solution and a first organic solvent and phase-separating the mixture into a fourth analysis solution as an organic phase and an aqueous phase to obtain the fourth analysis solution;
mixing the fourth analysis solution and a coloring liquid containing rhodamine B to obtain a fifth analysis solution; and
evaluating a concentration of the pentavalent antimony ions in the first analysis solution from color of the fifth analysis solution,
wherein a total concentration of nitric acid, cerium (IV) nitrate, and cerium (IV) sulfate contained in the first analysis solution is 0.00 mol/L or more and 0.1 mol/L or less,
the total concentration of nitric acid, cerium (IV) nitrate, and cerium (IV) sulfate contained in the first acid is 0.00 mol/L or more and 0.1 mol/L or less, and
the total concentration of nitric acid, cerium (IV) nitrate, and cerium (IV) sulfate contained in the second acid is 0.00 mol/L or more and 0.1 mol/L or less.

2. The analysis method according to claim 1, wherein a pH of the first analysis solution is −1 or more and 3 or less, and
a pH of the second analysis solution is −1 or more and 3 or less.

3. The analysis method according to claim 1, wherein the first acid contains 2 mol/L or more and 12 mol/L or less of hydrochloric acid and/or 2 mol/L or more and 18 mol/L or less of sulfuric acid.

4. The analysis method according to claim 1, wherein the second acid contains 2 mol/L or more and 12 mol/L or less of hydrochloric acid.

5. The analysis method according to claim 1, wherein the first analysis solution does not contain nitric acid, cerium (IV) nitrate, and cerium (IV) sulfate,
the first acid does not contain nitric acid, cerium (IV) nitrate, and cerium (IV) sulfate, and
the second acid does not contain nitric acid, cerium (IV) nitrate, and cerium (IV) sulfate.

6. The analysis method according to claim 1, wherein a pH of the first analysis solution is −1 or more and 1 or less, and
a pH of the second analysis solution is −1 or more and 1 or less.

7. The analysis method according to claim 1, wherein a mixing volume ratio of the first analysis solution and the first acid is represented by [amount of the first acid]/[amount of the first analysis solution], and
the mixing volume ratio is 1 or more and 100 or less.

8. The analysis method according to claim 1, wherein the first organic solvent is one or more selected from the group consisting of diisopropyl ether, diethyl ether, ethyl methyl ether, dibutyl ether, 1-octanol, chloroform, carbon tetrachloride, benzene, and hexane.

9. The method of analyzing an antimony ion according to claim 1, further comprising:
mixing the first analysis solution or the second analysis solution with a third acid to obtain a sixth analysis solution in which trivalent antimony ions are oxidized into pentavalent antimony ions;
mixing the sixth analysis solution with a fourth acid to obtain a seventh analysis solution containing [SbCl₆]⁻ ions in which pentavalent antimony ions contained in the first analysis solution and pentavalent antimony ions in which trivalent antimony ions contained in the first analysis solution are oxidized are chlorinated;
mixing the seventh analysis solution with a second organic solvent and phase-separating the mixture into an eighth analysis solution as a second organic phase and an aqueous phase to obtain the eighth analysis solution;
mixing the eighth analysis solution and a coloring liquid containing rhodamine B to obtain a ninth analysis solution;
evaluating a total concentration of trivalent antimony ions and pentavalent antimony ions in the first analysis solution from color of the ninth analysis solution; and
comparing a color of the fifth analysis solution with the color of the ninth analysis solution to evaluate a concentration of trivalent antimony ions contained in the first analysis solution,
wherein the third acid contains one or more selected from the group consisting of nitric acid, cerium (IV) nitrate, and cerium (IV) sulfate.

10. The analysis method according to claim 9, wherein the total concentration of nitric acid, cerium (IV) nitrate, and cerium (IV) sulfate in the third acid is 0.02 mol/L or more and 1.0 mol/L or less.

11. The analysis method according to claim 9, wherein the fourth acid contains 2 mol/L or more and 12 mol/L or less of hydrochloric acid.

12. The analysis method according to claim 9, wherein a color chart is used in the comparing the color of the fifth analysis solution with the color of the ninth analysis solution to evaluate the concentration of trivalent antimony ions contained in the first analysis solution.

13. An inspection tool used for analyzing pentavalent antimony ions, the inspection tool comprising:
a first container containing a first acid in which a total concentration of nitric acid, cerium (IV) nitrate, and cerium (IV) sulfate is 0.00 mol/L or more and 0.1 mol/L or less;
a second container containing a second acid in which the total concentration of nitric acid, cerium (IV) nitrate, and cerium (IV) sulfate is 0.00 mol/L or more and 0.1 mol/L or less;
a third container containing a first organic solvent; and
a fourth container containing a coloring liquid containing rhodamine B.

14. An inspection tool used for analyzing an antimony ion according to its valence, the inspection tool comprising:
a first container containing a first acid in which a total concentration of nitric acid, cerium (IV) nitrate, and cerium (IV) sulfate is 0.00 mol/L or more and 0.1 mol/L or less;
a second container containing a second acid in which the total concentration of nitric acid, cerium (IV) nitrate, and cerium (IV) sulfate is 0.00 mol/L or more and 0.1 mol/L or less;
a third container containing a first organic solvent as one or more selected from the group consisting of diisopropyl ether, diethyl ether, ethyl methyl ether, dibutyl ether, 1-octanol, chloroform, carbon tetrachloride, benzene, and hexane;
a fourth container containing the coloring liquid containing rhodamine B;
a fifth container containing the third acid in which a total concentration of cerium (IV) nitrate and cerium (IV) sulfate is 0.02 mol/L or more and 1.0 mol/L or less;
a sixth container containing a fourth acid containing 2 mol/L or more and 12 mol/L or less of hydrochloric acid; and
a seventh container containing a second organic solvent as one or more selected from the group consisting of diisopropyl ether, diethyl ether, ethyl methyl ether, dibutyl ether, 1-octanol, chloroform, carbon tetrachloride, benzene, and hexane.
